(19) United States
(12) Patent Application Publication
(10) Pub. No.: US 2007/0279421 A1
(43) Pub. Date: Dec. 6, 2007

(54) Vertex Shader Binning

(76) Inventors: Andrew Gruber, Arlington, MA (US); Aaftab Munshi, Los Gatos, CA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/420,965

(22) Filed: May 30, 2006

(51) Int. Cl. G06F 15/16

(52) U.S. Cl. 345/502

(57) ABSTRACT

A system for rendering three-dimensional graphics for display on a display using bins, the system including a graphics rendering engine configured to receive information representative of three-dimensional (3-D) objects in an object space and to render an image for display on the display, the graphics rendering engine including a processor, a pixel shader configured to perform rendering operations, and a programmable vertex shader configured to perform rendering operations, wherein the graphics rendering engine is configured to perform rendering operations and to compute locations of vertices of polygons corresponding to the 3-D objects.

### BACKGROUND

Two-dimensional (2-D) images representing three-dimensional (3-D) objects are used in many types of modern computer programs such as video games and computer assisted design (CAD) software. The rendering of images has increased, and continues to increase, in both speed and complexity to better simulate real-life scenarios (e.g., the speed at which a plane moves, or the presence of individual blades of grass on a golf course, etc.). Increases in resolution of images typically means increasing complexity of the rendering of 3-D objects in 2-D, with the 3-D objects being represented in 2-D using many small 2-D objects to give the appearance of a larger 3-D object.

A 3-D object is typically rendered in a 2-D image using one or more polygons, which can represent the “skin” of the 3-D object. For example, to represent a sphere in a 2-D image, several hundred polygons may be used with each polygon being rendered individually. Individual polygons can be shaded, colored, and/or wrapped with another image while rending a 3-D object as a 2-D image, e.g., to create the perception of depth. The polygons can be selectively rendered to represent 3-D objects from different view angles or perspectives in 2-D images. The objects (and 2-D representations of the objects) can be represented in various “spaces” according to the geometric coordinate system used to locate objects in the space. For example, in “object” space, the center of a 3-D object can be at (0,0,0) with protrusions in both the negative and positive directions. When the object space is converted to 2-D “screen” space, an object in the object space is converted into a 2-D image and is located in the screen space using, for example, a coordinate system that extends from 0 to 479 in the X direction and 0 to 639 in the Y direction.

### SUMMARY

In general, in an aspect, the invention provides a system for rendering three-dimensional graphics for display on a display using bins, the system including a graphics rendering engine configured to receive information representative of three-dimensional (3-D) objects in an object space and to render an image for display on the display, the graphics rendering engine including a processor, a pixel shader configured to perform rendering operations, and a programmable vertex shader configured to perform rendering operations, wherein the graphics rendering engine is configured to perform rendering operations and to compute locations of vertices of polygons corresponding to the 3-D objects.

Implementations of the invention can include one or more of the following features. The programmable vertex shader is further configured to associate corresponding BinIDs with vertices of the polygons based on locations of the vertices. The programmable vertex shader is configured to operate in a first state to compute a location of the vertices, and in a second state to render the image for display on the display. The graphics rendering engine further includes a memory, the programmable vertex shader being further configured to cause the BinID to be stored in the memory. The pixel shader is a programmable pixel shader, wherein the programmable vertex shader is configured to cause the pixel shader to store the BinIDs in the memory using point primitives. The programmable vertex shader is configured to convert the object space into a clip space. The pixel shader and the programmable vertex shader are implemented using a single unified shader. The processor is configured to convert bin coordinates into a BinID.

In general, in another aspect, the invention provides a method for rendering three-dimensional graphics using bins, the method includes receiving, at a programmable vertex shader, information representative of 3-D objects in an object space, converting the information representative of objects in an object space into information representative of the objects in a clip space, computing locations of vertices of polygons corresponding to the 3-D objects using the vertex shader, performing a first rendering operation using the programmable vertex shader, and performing a second rendering operation using a pixel shader.

Implementations of the invention can include one or more of the following features. The method further includes associating corresponding BinIDs with vertices of the polygons, using the programmable vertex shader, based on locations of the vertices. The method further includes storing the BinIDs in a memory. The method further includes causing a pixel shader to send point primitives towards the memory for storage. The method further includes performing the first rendering operation using a unified shader. The method further includes performing the second rendering operation using a unified shader. The method further includes converting bin coordinates into a BinID.

In accordance with implementations of the invention, one or more of the following capabilities can be provided. Binning can be performed using a programmable vertex shader. Less hardware, less memory bandwidth, and/or less power can be used to render an image for display on a display compared with prior methods. The cost of graphics rendering systems can be reduced compared with prior systems. Binning can be performed with greater flexibility when compared with prior methods. For example, the quantity of bins used to render an image and/or the size of the bin identity of an object can be changed without redesigning hardware used in the graphics rendering process.

These and other capabilities of the invention, along with the invention itself, will be more fully understood after a review of the following figures, detailed description, and claims.

### BRIEF DESCRIPTION OF THE FIGURES

FIG. 1 is a block diagram of a graphics system used to create and display images.

FIG. 2 is a block diagram of a rendering engine in the graphics system of FIG. 1

FIG. 3 is a diagram of a clip space divided into multiple bins.

FIG. 4 is a diagram of a data structure used to store information associated with polygons used to create a 2-D image.

FIG. 5 is a diagram of a data structure used to store information associated with polygons used to created a 2-D image.

FIG. 6 is a block flow diagram of a process of binning vertices of a polygon using a programmable vertex shader shown in FIG. 2.

FIG. 7 is a diagram of a clip space divided into multiple bins.

### DETAILED DESCRIPTION

Embodiments of the invention provide techniques for performing binning during a graphics rendering process using a programmable vertex shader. A programmable vertex shader determines the locations of polygon vertices to determine which bins(s) the vertices intersect and assigns the vertices to bins corresponding to portions of a display screen. A rendering engine renders polygons for each image frame. The rendering engine examines polygon vertices to determine if a particular polygon intersects the particular bin being rendered. If the polygon intersects the particular bin, then the portion of the polygon corresponding to the bin is rendered. If the polygon does not intersect a particular bin, the polygon is not rendered. Other embodiments are within the scope of the invention.

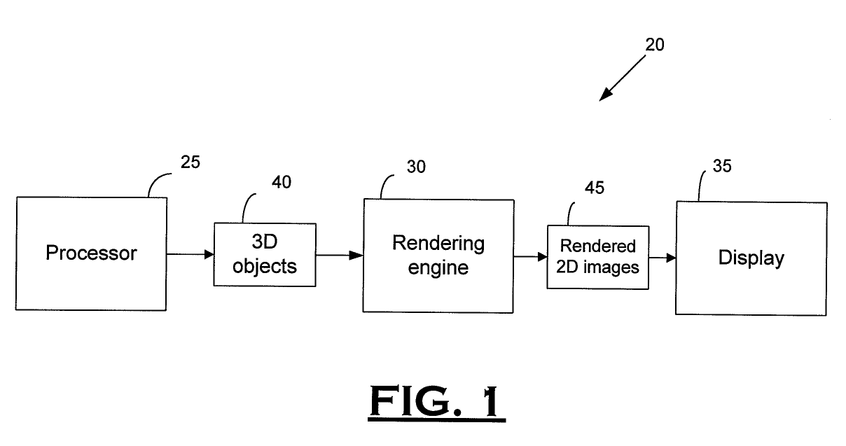

Referring to FIG. 1, a graphics system 20 includes a processor 25, a rendering engine 30, and a display 35. The processor 25 is preferably a microprocessor such as a CPU in a video game system. The rendering engine 30 is preferably a graphics card contained within the video gaming system. The display 35 is, for example, a computer screen. The processor 25 is configured to provide an information stream 40 representative of 3-D objects in an object space to the rendering engine 30. The processor 25 can control, for example, movement and placement of objects within the object space, aiming of a camera (i.e., a point of view in the object space), and/or a level of detail of the 3-D objects. The rendering engine 30 is configured to convert (as described more fully below) the 3-D information contained within the information stream 40 into a 2-D screen space. The rendering engine 30 can provide an information stream 45, which includes information representative of a 2-D image of the 3-D object space, to the display 35. The display 35 is configured to receive the information stream 45 and display an image indicated by the information contained within the information stream 45.

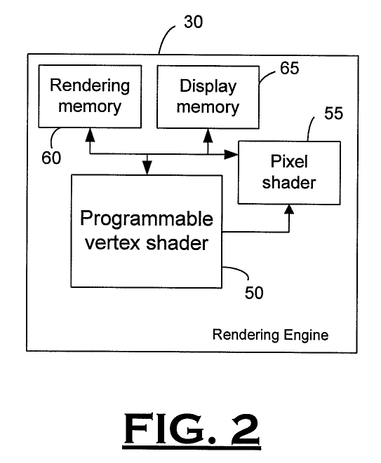

Referring to FIG. 2, the rendering engine 30 includes a programmable vertex shader 50, a pixel shader 55, a rendering memory 60, and a display memory 65. The vertex shader 50 can be, for example, dedicated hardware that is part of the rendering engine 30, a vertex shader program running on a general purpose processor. The vertex shader 50 is configured to execute code that will calculate vertex locations and ultimately binIDs. While the vertex shader 50 is shown as being part of the rendering engine 30, other configurations are possible, e.g., the vertex shader 55 can be located externally from the rendering engine 30. The pixel shader 55 can be, for example, dedicated hardware that is part of the rendering engine 30 or can be a pixel shader program running on a general purpose processor. The functionality provided by the vertex shader 50 and the pixel shader 55 can be combined in a single unit, e.g., piece of hardware (e.g., a unified shader providing vertex shading capabilities and pixel shading capabilities) and/or be implemented using, for example, vertex and pixel shader programs running on a single general purpose processor. The rendering memory 60 is memory such as random access memory (RAM). The display memory 65 is memory such as RAM. The rendering memory 60 can be smaller than the amount of memory needed to render an entire image. The vertex shader 50 and the pixel shader 55 are coupled to the rendering memory 60 and the display memory 65, although other configurations are possible (e.g., only the pixel shader 55 can be connected to the rendering memory 60 and the display memory 65). The rendering engine 30 can also contain other components such as additional memory, multiplexors, demultiplexors, transceivers, etc.

The vertex shader 50 can perform multiple functions and/or serve several purposes for graphics rendering. The vertex shader 50 is configured to receive commands from a driver residing on a controller (not shown) such as a CPU contained within an attached PC. The commands can cause the vertex shader 50 to operate in different modes, such as a “rendering mode” and a “binning mode.” In the rendering mode, the vertex shader 50 can provide special effects used in the process of converting the 3-D object space to the 2-D screen space by performing mathematical operations on vertices of individual polygons. For example, the vertex shader 50 can convert the position of the vertices from object space into clip space, change the color of a vertex, change the texture of a vertex, and/or change the position of the vertex. The vertex shader 50 can transfer the contents of the memory 60 to the display memory 65 for use in displaying an image.

The vertex shader 50 can determine the location of vertices of the individual polygons making up the 3-D object space. The vertex shader 50 is configured to use a fixed correspondence that exists between the clip space and the screen space to determine what clip space coordinates correspond to a particular bin. Thus, operating in the clip space, the vertex shader 50 can compute the location of vertices as they will appear in the screen space and assign BinIDs to each vertex (as described below).

The pixel shader 55 is configured to calculate effects used in rendering the 2-D image on a per-pixel basis, such as color, and/or texture of an object in the 3-D object space. The pixel shader 55 is configured to place rendered 2-D images into the rendering memory 60.

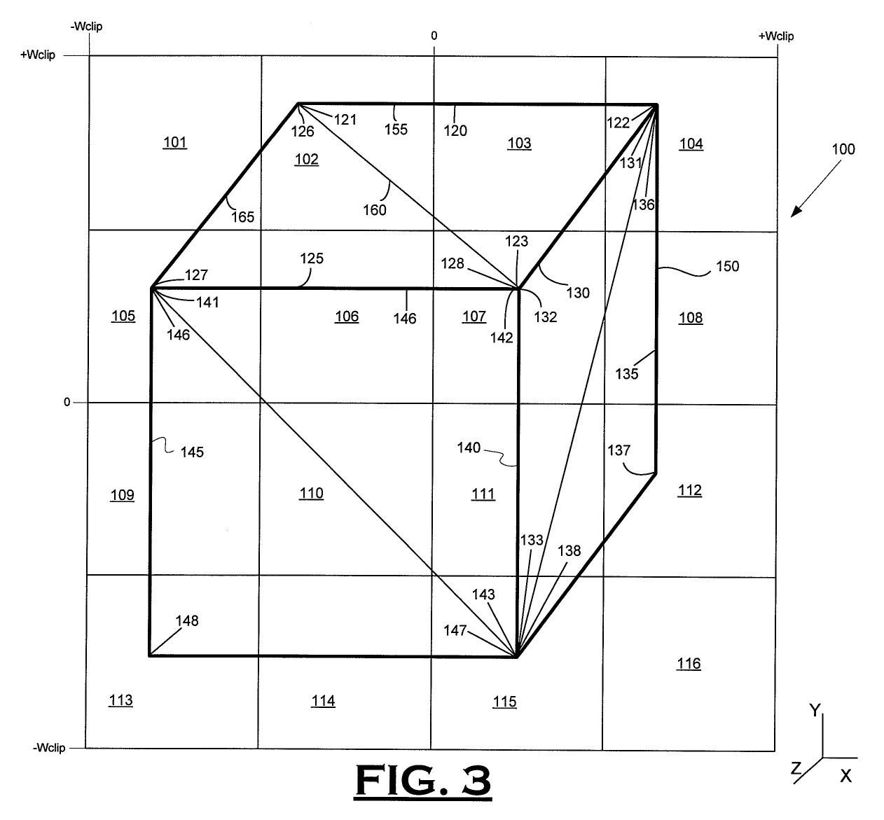

Referring also to FIG. 3, a clip space 100 (shown as a 2-D image in FIG. 3) includes bins 101 through 116 and polygons 120, 125, 130, 135, 140, and 145. The polygons 120, 125, 130, 135, 140, and 145 correspond to a cube 150 contained within the clip space 100. Each of the bins 101 through 116 have a corresponding unique ID and/or a quasi-unique ID (e.g., an X-Y coordinate system, where the X-axis bins are numbered one through four and the y-axis bins are also numbered one through four). The quantity of bins can be fixed or can change as graphics processing occurs and can be a function of several variables such as the size of the rendering memory 60 and/or the complexity of the image being rendered. The 2-D image can be rendered by the rendering engine 50 in several passes, each pass corresponding to one or more of the bins 101 through 116. For example, if the rendering memory 60 can hold one-fiftieth of the complete rendered 2-D image, fifty bins (or more) can be used. Likewise, if the rendering memory 60 can hold one-half of the rendered 2-D image, then two or more bins can be used. While the bins 101 through 116 are shown as square, other shapes are possible, such as rectangular. Furthermore, while not shown in FIG. 3, the clip space 100 may include multiple bins in the z-axis.

To render a 2-D image of the clip space 100 using bins, the bins 101 through 116 are preferably individually rendered and combined. For example, to render the clip space 100 into a 2-D image, sixteen rendering passes can be used. Each rendering pass can render the contents of a single one of the bins 101 through 116. When the vertex shader 50 is rendering the bin 101, preferably only the portions of the polygons 120 and 125 that intersect the bin 101 are rendered. As each of the bins 101 through 116 are rendered by the rendering engine 30 (e.g., using the vertex shader 50 (while in rendering mode) and/or the pixel shader 55), the rendered 2-D image portion corresponding to the bin being rendered is stored in the rendering memory 60. The rendering engine transfers the contents of the rendering memory 60 to the display memory 65, e.g., after the bin is completely rendered. A 2-D image of the clip space 100 can be created by combining the rendered images corresponding to the bins 101 through 116.

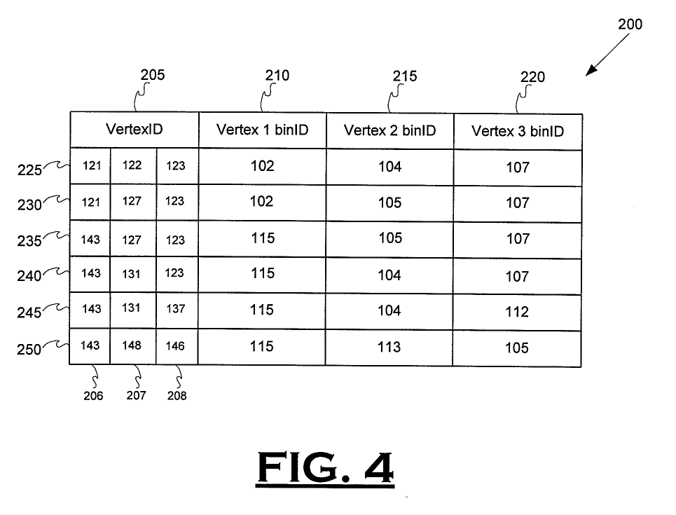

The vertex shader 50 is configured to “bin” the vertices of the polygons 120, 125, 130, 135, 140, and 145 by computing the positions of the vertices corresponding to the polygons 120, 125, 130, 135, 140, and 145 and associating the vertices with corresponding bins. The shader 50 can assign a BinID to each polygon vertex. For example, the vertex shader 50 is configured to determine the location of vertices 121, 122, and 123 of the polygon 120. The computed position of the vertex 121 corresponds to (e.g., lies within the area of) the bin 102, and is assigned a BinID corresponding to bin 102. The computed position of the vertex 122 corresponds to the bin 104, and is assigned a BinID for bin 104. The computed position of the vertex 123 corresponds to the bin 107, and is assigned a BinID for bin 107. Vertices that lie outside of the clip space (e.g., outside of a clip space frustum) are assigned a BinID corresponding to a bin outside of the viewable portion of the clip space (the bins outside of the viewable portion, however, are not rendered, as described below). Each BinID can be written to a linear structure (e.g., as shown in FIG. 4) by the vertex shader 50 using, e.g., a streaming output, or point primitives produced by the pixel shader 55.

Referring to FIG. 4, e.g., a data structure 200 includes a VertexID column 205, and BinID columns 210, 215, and 220. Values for the VertexIDs and BinIDs for each polygon are provided in respective polygon entries 225, 230, 235, 240, 245, and 250 (with each entry containing a one or more VertexIDs and appropriate, here three, vertex BinID values). Each of the polygon entries 225, 230, 235, 240, 245, and 250 correspond to a polygon that appears in the clip space 100. The VertexID column 205 includes sub-fields 206, 207, and 208. Each respective polygon entry 225, 230, 235, 240, and 250 can include three VertexIDs corresponding to its three respective vertices. For example, polygon entry 225 includes three VertexIDs 121, 122, and 123 corresponding to sub-fields 206, 207, and 208, respectively.

The BinID columns 210, 215, and 220 contain BinIDs corresponding to the vertices of the polygons 120, 125, 130, 135, 140, and 145. For example, for the object 150 in FIG. 3, the VertexIDs corresponding to the polygon 120 is included in the data structure 200 at polygon entry 225. As the vertex shader 50 determines in which bins the vertices of the polygon 120 lie, the vertex shader 50 adds a BinID for each vertex to the appropriate column of the polygon entry 225. For example, the BinID 210 in the polygon entry 225 has a value indicating the bin 102. The BinID 215 in the polygon entry 225 has a value representing the bin 104. The BinID 220 in the polygon entry 225 has a value representing the bin 107. While the VertexID column 205 and the BinID columns 210, 215, and 220 are shown as a single data structure (here, the data structure 200), other configurations are possible. For example, the VertexID column 205 can be located in a first data structure and the BinID columns 210, 215, and 220 can be located in a second data structure that is linked to the first data structure. Each of the BinID columns 210, 215, and 220 correspond to one of the sub-fields 206, 207, and 208. For example, the BinID column 210 corresponds to sub-field 206, the BinID column 215 corresponds to sub-field 207, and the BinID column 220 corresponds to sub-field 208.

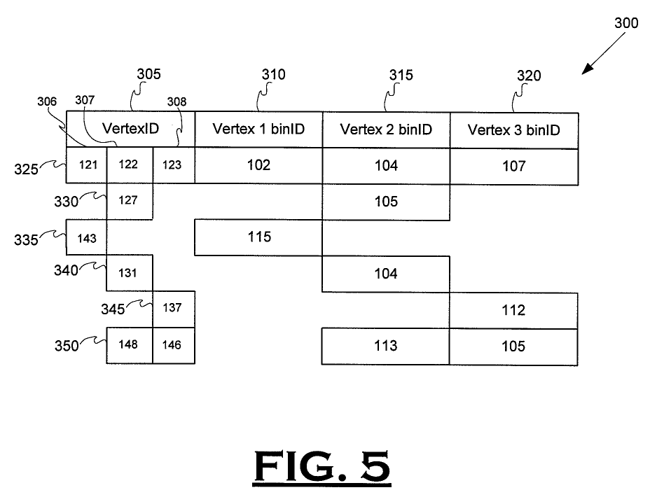

Referring to FIGS. 2-5, e.g., a data structure 300, includes a VertexID column 305 and BinID columns 310, 315, and 320. As described above with respect to the data structure 200, values for the VertexIDs and BinIDs for each polygon are provided in respective polygon entries 325, 330, 335, 340, 345, and 350 (with each polygon entry including one or more VertexIDs and one or more vertex BinIDs). Each of the polygon entries 325, 330, 335, 340, 345, and 350 correspond to a polygon that appears in the clip space 100. The VertexID column 305 includes sub-fields 306, 307, and 308. If less than all three of the sub-fields 306, 307, and 308 are used (as described below), certain of the sub-fields 306, 307, and 308 are omitted (e.g., the polygon entry 330 consists only of sub-field 307). Each respective polygon entry 325, 330, 335, 340, 345, and 350 can include one or more VertexIDs. For example, as described above with respect to data structure 200, some polygon entries (e.g., polygon entry 325) include three VertexIDs (one in each of the sub-fields 306, 307, and 308). For successive polygons appearing in the data structure 300 (e.g., polygon entries 325 and 330), a single VertexID can be used to indicate another polygon because the other missing vertices assumed to be shared with the previous polygon. Thus, less than all three of the sub-fields 306, 307, and 308 may be used to represent a successive polygon that has vertex points in common with a previous polygon. For example, polygon entry 325 includes VertexIDs 121, 122, and 123, which are stored in sub-fields 306, 307, and 308, respectively. The next polygon entry 330 has two vertices in common with the polygon entry 325 (e.g., the VertexIDs 121 and 123) and includes only a single VertexID (i.e., the Vertex ID 127). Unused ones of the sub-fields 306, 307, and 308 are omitted from the data structure 300 (forming a “strip list”). Thus, the data structure 200 configuration shown in FIG. 4 is exemplary only, and not limiting of the invention as other implementations in accordance with the disclosure are possible.

The BinID columns 310, 315, and 320 contain BinIDs corresponding VertexID entries present in the VertexID column 305. For example, the polygon entry 330 only uses a single BinID entry that corresponds to the VertexID entry 127. The vertex shader 50 is configured to determine the BinID corresponding to each Vertex of each of the polygons in the clip space 100, as described above with respect to the data structure 200. When using the data structure 300, however, the vertex shader 50 preferably determines the BinID corresponding to vertices that differ from the vertices of a previously examined one of the polygon entries 325, 330, 335, 340, 345, and 350. For example, the VertexID 127 is the only VertexID that differs between the polygon entries 325 and 330, thus the vertex shader 50 preferably computes only a BinID corresponding to the VertexID 127. While the VertexID column 305 and the BinID columns 310, 315, and 302 are shown as a single data structure (here, the data structure 300), other configurations are possible. For example, the VertexID column 305 can be located in a first data structure and the BinID columns 310, 315, and 320 can be located in a second data structure that is linked to the first data structure. Furthermore, the vertex shader 50 can be configured to store a value representative of a position of a vertex substantially contemporaneously with storing the binID.

The vertex shader 50 assigns a BinID to each vertex under examination by correlating each vertex with a specific polygon, rather than determining the location of a vertex in the clip space 100 without reference to how many polygons are associated with the vertex. For example, the cube 150 includes line segments 155, 160, and 165, which converge at identically located vertices 121 and 126. Though the coordinates of the vertices 121 and 126 are identical, each of the vertices 121 and 126 can receive a separate BinID entry in the data structure 200.

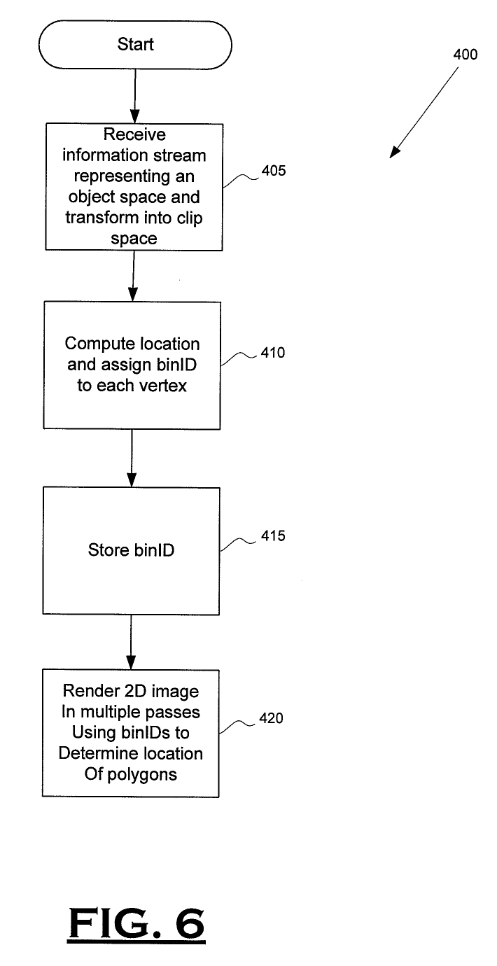

In operation, referring to FIG. 6, with further reference to FIGS. 1-5, a process 400 for binning polygon vertices and rendering images in accordance with binned polygons using the system 20 includes the stages shown. In the process 400, vertices of polygons are binned using a programmable vertex shader. The process 400, however, is exemplary only and not limiting. The process 400 may be altered, e.g., by having stages added, removed, or rearranged.

At stage 405, the rendering engine 30 receives the information stream 40 from the processor 25. The information stream 25 can include information that is representative of objects in the 3-D object space. The processor 25 generates indicia of the objects using, for example, application software (e.g., a video game, CAD software, etc.). The vertex shader 50 (while operating in binning mode) transforms the 3-D object space into 3-D clip space. Alternatively, the vertex shader 50 can receive back-converted information (e.g., information representative of the clip space converted from the screen space) from another component (e.g., a processor).

At stage 410, the vertex shader 50 (operating in binning mode) determines which polygons are present in the clip space. The vertex shader computes the location of each vertex of each of the polygons present in the clip space by determining the coordinates of each vertex and matching the coordinates to a specific bin (e.g., the bins 101 through 116). For example, the vertex shader 50 is programmed by a driver operating on a controller. The vertex shader 50 performs a 3×4 matrix transformation on the incoming polygons corresponding to objects in the object space (e.g., Xobject, Yobject, and Zobject) to produce a clip space representation:
(Xclip, Yclip, Zclip, Wclip)
   where Xclip, Yclip, and Zclip are the coordinates of a vertex contained within the clip space, and −Wclip and +Wclip are the outer boundaries of the clip space. The program outputs a “Position in Clip Space” for each polygon in the clip space. Vertices are visible within the clip space when:

TABLE 1

−Wclip < Xclip < +Wclip
−Wclip < Yclip < +Wclip
−Wclip < Zclip < +Wclip

The visible portion of the clip space 100 is divided into the bins, e.g., 4 bins in an X-direction, 4 bins in a Y-direction, and 1 bin in a Z-direction. Additionally there are 2 bins in each direction that represent an area outside of the clip space 100. The bins can be defined as (using the X-axis as an example):

TABLE 2

Xbin 0 = Xclip < −Wclip
Xbin 1 = −Wclip < Xclip < −Wclip * ½
Xbin 2 = −Wclip * ½ < Xclip < 0
Xbin 3 = 0 < Xclip < Wclip * ½
Xbin 4 = Wclip * ½ < Xclip < Wclip
Xbin 5 = Xclip > Wclip

The vertex shader 50 determines the coordinates of each vertex contained in (or outside of) the clip space 100 and assigns an identifier as defined by Table 2 (and similar tables for the y-axis and z-axis). Three identifiers are generated for each vertex within the clip space corresponding to the x-axis bin, the y-axis bin, and the z-axis bin. The vertex shader 50 converts the three identifiers into a single unique identifier (e.g., the BinIDs 101, 102, and 103 of FIG. 3) that is stored in the data structure 200.

At stage 415, the BinID associated with each vertex of each polygon is stored in a linear data array, such as the data structure 200. The BinIDs are written out to the data structure 200 by the vertex shader 50 using a streaming output capability of the vertex shader 50. Alternatively, the vertex shader 50 can cause the BinIDs to be stored in the data structure 200 by instructing the pixel shader 55 to generate point primitives that are stored in the data structure 200.

At stage 420, the rendering engine 30 transforms the 3-D object space into 2-D screen space and renders a 2-D image for display on the display 35. Each of the bins 101 through 116 are rendered individually. For example, as the bin 101 is rendered, the output of the vertex shader 50 (operating in rendering mode) and/or the pixel shader 55 are stored in the rendering memory 60. After bin 101 is rendered, the content of the rendering memory 60 is transferred to the display memory 65. As each of the bins 101 through 116 are rendered, the contents of the rendering memory 60 are transferred to the display memory 65. After all of the bins 101 through 116 are rendered, the individual rendered bins stored in the display memory 65 are combined to form a complete 2-D image for display on the display 35.

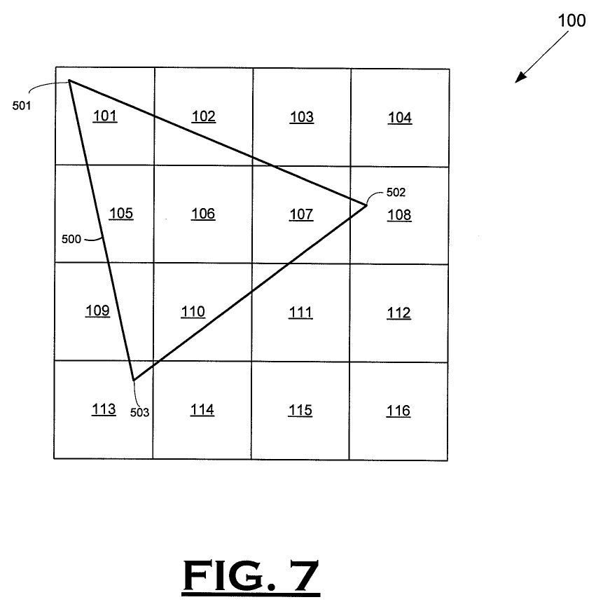

To render the bin 101, the rendering engine fetches all of the BinIDs present in the data structure 200. The rendering engine assembles the BinIDs into groups of three. Each group of three BinIDs represents the three BinIDs associated with three vertices of a polygon under examination. The rendering engine determines, using the BinIDs, whether any portion of the polygon under examination appears in the bin being rendered. If none of the polygon under examination appears in the bin being rendered, the polygon can be disregarded (e.g., not rendered during the present rendering pass). For example, in FIG. 7, the clip space 100 includes a polygon 500 with corresponding VertexIDs 501, 502, and 503. When rendering the bin 106, the rendering engine fetches a group of three BinIDs corresponding to the VertexIDs 501, 502, and 503. Using the group of three BinIDs, the rendering engine determines that even though no vertex of the polygon 500 appears in the bin 106, the polygon 500 intersects the bin 106. Thus, the corresponding portions of the polygon 500 are rendered when the rendering engine renders the bin 106. While the rendering engine has been described as performing the above functions, other pieces of hardware and/or software modules can perform the above functions.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations. The rendering engine 30 can render more than a single bin in each rendering pass (e.g., rendering four bins at a time to render a sixteen bin image).

While the rendering engine 30 can include the components and connections shown in FIG. 2, other configurations are possible. For example, a rendering engine can contain additional memory, additional microprocessors, additional pixel shaders, additional vertex shaders, transceivers, multiplexors, etc.

The terms “connected” and/or “coupled,” as used herein, includes direct connection and/or indirect connections through other components. For example, two components connected to each other can include indirect connections through other components such as resistors, transistors, buffers, routers, switches, hubs, processors, decrypters, memories, shaders, etc.

Referring to FIGS. 3-5, while vertices and corresponding entries in the data structures 200 and 300 have been shown as including multiple Vertex IDs for each identically located vertex (e.g., the VertexIDs 123, 128, 132, and 142 all correspond to a single vertex), other configurations are possible. For example, a single VertexID can be assigned to each unique vertex in the clip space 100 regardless of which polygon the vertex is associated with.

Further, while the description above refers to the invention, the description may include more than one invention.

What is claimed is:

1. A system for rendering three-dimensional graphics for display on a display using bins, the system comprising:
a graphics rendering engine configured to receive information representative of three-dimensional (3-D) objects in an object space and to render an image for display on the display, the graphics rendering engine comprising:
a processor;
a pixel shader configured to perform rendering operations; and
a programmable vertex shader configured to perform rendering operations;
wherein the graphics rendering engine is configured to perform rendering operations and to compute locations of vertices of polygons corresponding to the 3-D objects.

2. The system of claim 1 wherein the programmable vertex shader is further configured to associate corresponding BinIDs with vertices of the polygons based on locations of the vertices.

3. The system of claim 1 wherein the programmable vertex shader is configured to operate in a first state to compute a location of the vertices, and in a second state to render the image for display on the display.

4. The system of claim 1 wherein the graphics rendering engine further comprises a memory, the programmable vertex shader being further configured to cause the BinID to be stored in the memory.

5. The system of claim 4 wherein the pixel shader is a programmable pixel shader, wherein the programmable vertex shader is configured to cause the pixel shader to store the BinIDs in the memory using point primitives.

6. The system of claim 2 wherein the programmable vertex shader is configured to convert the object space into a clip space.

7. The system of claim 1 wherein the pixel shader and the programmable vertex shader are implemented using a single unified shader.

8. The system of claim 1 wherein the processor is configured to convert bin coordinates into a BinID.

9. A method for rendering three-dimensional graphics using bins, the method comprising:
receiving, at a programmable vertex shader, information representative of 3-D objects in an object space;
converting the information representative of objects in an object space into information representative of the objects in a clip space;
computing locations of vertices of polygons corresponding to the 3-D objects using the vertex shader;
performing a first rendering operation using the programmable vertex shader; and
performing a second rendering operation using a pixel shader.

10. The method of claim 9 further comprising associating corresponding BinIDs with vertices of the polygons, using the programmable vertex shader, based on locations of the vertices.

11. The method of claim 10 further comprising storing the BinIDs in a memory.

12. The method of claim 11 wherein storing the BinIDs comprises causing a pixel shader to send point primitives towards the memory for storage.

13. The method of claim 11 wherein performing the first rendering operations using the programmable vertex shader includes performing the first rendering operation using a unified shader.

14. The method of claim 11 wherein performing the second rendering operation includes performing the second rendering operation using a unified shader.

15. The method of claim 13 wherein performing the second rendering operation includes performing the second rendering operation using a unified shader.

16. The method of claim 9 further comprising converting bin coordinates into a BinID.
